(19) United States
(12) Patent Application Publication
(10) Pub. No.: US 2006/0058438 A1
(43) Pub. Date: Mar. 16, 2006

(54) Fluid sulfopolyester formulations and products made therefrom

(76) Inventors: Thomas Hugh Williams, Fall Branch, TN (US); Terry Ann Oldfield, Kingsport, TN (US)

Correspondence Address: Michael J. Blake;Eastman Chemical Company, P.O. Box 511, Kingsport, TN, 37662-5075, US

(21) Appl. No.: 11/220,486

(22) Filed: Sep. 7, 2005

Related U.S. Application Data
(60) Provisional application No. 60/610,497, filed on Sep. 16, 2004.

(51) Int. Cl. C08K 5/05

(52) U.S. Cl. 524/379

(57) ABSTRACT

A branched sulfopolyester mixture useful in adhesive and personal care product formulations. The branched sulfopolyester mixture includes: I) from about 65 to about 95 weight % of a branched water-dispersible polyester; and II) from about 5 to about 35 weight % of an alcohol. The branched sulfopolyester mixture is pourable at room temperatures.

### CROSS REFERENCE TO RELATED APPLICATIONS

Benefit is claimed to the earlier filed application having U.S. Ser. No. 60/610,497 filed Sep. 16, 2004, the entire disclosure of which is incorporated herein by reference.

The present invention relates to a composition having a sulfopolyester and an alcohol that is substantially fluid at temperatures above 25° C. More particularly, the present invention relates to a blended composition having from about 65 to about 95 weight % of a sulfopolyester and from 5 to about 35 weight % of an alcohol.

### BACKGROUND OF THE INVENTION

Sulfopolyesters are well known to those skilled in the art. Generally, sulfopolyesters are water-dissipatable and essentially derived from the following components: A) at least one dicarboxylic acid; B) at least one diol where at least 20 mole percent of the diol is composed of an ethylene glycol having the formula H(OCH₂CH₂)ₙOH where n is an integer of from two to about twenty; and C) at least one difunctional dicarboxylic acid sulfomonomer containing a —SO₃M group attached to an aromatic nucleus, wherein M is hydrogen or an alkali metal salt Na⁺, Li⁺, K⁺, Mg⁺⁺, Ca⁺⁺, Cu⁺⁺, Fe⁺⁺, Fe⁺⁺⁺, or a combination thereof. The sulfomonomer component of the polyester constitutes from about 8 mole percent to about 45 mole percent of the total moles in constituents A-C. Such water-dissipatable polyesters are described in greater detail in U.S. Pat. No. 3,546,008 issued to Shields et al.; U.S. Pat. No. 3,779,993 issued to Kibler et al.; and U.S. Pat. No. 5,543,488, the entire disclosures of which are incorporated herein by reference. The water-dissipatable sulfopolyesters may be branched or linear.

Such sulfopolyesters have found widespread utility in such areas as personal care applications, adhesive formulations, coatings and other products that can be dissolved, dispersed or otherwise dissipated in aqueous solutions, preferably at temperatures of less than about 80° C. For example, U.S. Pat. No. 3,734,874 issued to Charles Kibler on May 22, 1973 discloses a sulfopolyester having a glycol component or residue, a dicarboxylic acid component or residue and a difunctional monomer component. One skilled in the art will understand that the term “residue” or “component” as used in the specification and concluding claims, refers to the moiety that is the resulting product of the chemical species in a particular reaction scheme or subsequent formulation or chemical product, regardless of whether the moiety is actually obtained from the chemical species. Thus, for example, an ethylene glycol residue in a polyester refers to one or more —OCH₂CH₂O—repeat units in the polyester, regardless of whether ethylene glycol is used to prepare the polyester. Additionally, U.S. Pat. No. 6,346,234 discloses a hair styling composition wherein one component is a anionic fixative polymer. Preferred fixative polymers are sulfopolyesters marketed by Eastman Chemical Company under the trade names of AQ 1045, AQ 1350 and AQ 14000.

A problem with the above sulfopolyesters is their relatively low glass transition temperature, Tg, being below about 10° C. At temperatures below the Tg, a polymer is hard and glassy, while temperatures above the Tg result in a change to a soft and rubbery or sticky material. Convenient product forms, such as pellets or pastilles, are normally encountered for substantially amorphous polymers only when the Tg is not significantly lower than the ambient temperature. From a product-packaging viewpoint, ambient temperature can be defined as a nominal room temperature of 25° C. to a more climatic extreme of 50° C. Thus, when adding a solid sulfopolyester to an aqueous formulation, it must first be broken into small pieces by cryogenic grinding or by freezing the polymer below its Tg and then breaking it into pieces using a physical force. The ground or broken pieces must then be kept at a temperature below the Tg to keep them from agglomerating into a larger mass. With regard to adhesive applications, typically the solid sulfopolyesters are added in solid form as a block or slab to hot melt adhesive formulations that are heated to more than 150° C. The sulfopolyester softens enough at this temperature so that it can be blended with other components of the adhesive.

Another problem with the above sulfopolyesters is that for certain types of uses, such as cosmetics, hair styling compositions, or personal care products, the sulfopolyester is made into an aqueous dispersion. Typically, such formulations contain from 0.5 to 15 weight percent of the sulfopolyester and a significant amount of water. Over time, the sulfopolyester will hydrolyze, reducing the concentration of sulfopolyester. Additionally, the high concentration of water present in the dispersion adds to the cost of shipping.

Accordingly, there is a need for a water-dispersible or water-dissipatable branched sulfopolyester that is capable of being poured at room temperature without heating.

### SUMMARY OF THE INVENTION

Briefly, the fluid sulfopolyester of the present invention is a mixture having: I) from about 65 to about 95 weight % of a branched water-dispersible polyester; and II) from about 5 to about 35 weight % of an alcohol.

Another aspect of the present invention is an adhesive formulation incorporating from about 0.5 to about 80 weight % of the fluid sulfopolyester.

Yet another aspect of the present invention is a personal care product, such as a hair styling composition that includes the pourable branched sulfopolyester of the present invention.

These and other objects and advantages of the present invention will become more apparent to those skilled in the art in view of the following description. It is to be understood that the inventive concept is not to be considered limited to the constructions disclosed herein but instead by the scope of the appended claims.

### DETAILED DESCRIPTION OF THE INVENTION

It has been unexpectedly discovered a pourable, water-dispersible, branched sulfopolyester composition that can be used in a variety of applications, such as adhesive compositions and personal care products, can be prepared by mixing:

I. from about 65 to about 95 weight % of a branched water-dispersible polyester made from the residues or moieties of reaction products:

(A) at least one difunctional dicarboxylic acid which is not a sulfomonomer;

(B) about 2 to 30 mole percent, based on the total of all acid, hydroxyl and amino equivalence, of residues of at least one difunctional sulfomonomer containing at least one sulfonate group bonded to an aromatic ring wherein the functional groups are hydroxyl, carboxyl, or amino;

(C) at least one diol or a mixture of a diol and a diamine comprising:
(i) about 0.1 to 85 mole percent, based on the total mole percent of diol moieties or diol and diamine moieties, of a diol or diamine having the formula H(—OCH₂CH₂—)ₙOH and HRN(—(CH₂CH₂O—))ₙNHR wherein n is 2 to about 20 and R is hydrogen or C₁-C₆ alkyl provided that the mole percent of such moieties is inversely proportional to the value of n;
(ii) about 0.1 to 15 mole percent, based on the total mole percent of diol moieties or diol and diamine moieties, of moieties of a poly(ethylene glycol) having the formula H(—OCH₂CH₂—)ₙOH wherein n is 2 to about 500, provided that the mole percent of such moieties is inversely proportional to the value of n; and
(iii) 0 to greater than about 99 mole percent of the diol component or diol and diamine mixture being selected from the group consisting of a glycol and a mixture of glycol and diamine having two —NRH groups, the glycol containing two —C(R¹)₂ OH groups wherein R¹ in the reactant is a hydrogen atom, an alkyl of 1 to 5 carbon atoms, or an aryl group of 6 to 10 carbon atoms;

(D) 0 to about 40 mole % of a difunctional monomer reactant selected from the group consisting of hydroxycarboxylic acids having one —C(R—)₂—OH group, aminocarboxylic acids having one —NRH group, aminoalkanols having one —C(R—)₂—OH group and one —NRH group and mixtures of said difunctional reactants wherein R in the reactant is hydrogen or an alkyl group of 1 to 6 carbon atoms; and

(E) about 0.1 to 40 mole % of a “multifunctional” or “branch-inducing” reactant containing at least three functional groups selected from hydroxyl, carboxyl, amino, and mixtures thereof; and

II. from about 5 to about 35 weight % of an alcohol.

The polyester, component (I) of the present invention, contains substantially equal mole proportions of acid equivalents (100 mole %) and diol or diol and diamine equivalents (100 mole %), wherein at least 20 weight percent of the groups linking the moieties of the monomeric units are ester linkages. The inherent viscosity of the polyester, component (I), is at least 0.1 dL/g measured in a 60/40 parts by weight solution of phenol/tetrachloroethane at 25° C. and at a concentration of about 0.5 g of polymer in 100 ml of the solvent, the glass transition temperature Tg is no greater than 20 C.

Alternatively, component (I) of the present invention can be a blend of two different polyesters comprising:

(A) about 20 to 80 weight percent of the linear water-dispersible polyester composition made of the residues or moieties of reaction products;
(1) at least one difunctional dicarboxylic acid which is not a sulfomonomer;
(2) about 4 to 25 mole percent, based on the total of all acid, hydroxyl and amino equivalence, of residues of at least one difunctional sulfomonomer containing at least one sulfonate group bonded to an aromatic ring wherein the functional groups are hydroxyl, carboxyl, or amino;
(3) at least one diol or a mixture of a diol and a diamine comprising:
   (i) at least 15 mole percent, based on the total mole percent of diol moieties or diol and diamine moieties, of a diol or diamine having the formula H(—OCH₂CH₂—)ₙOH and HRN(—(CH₂CH₂O—))nNHR wherein n is 2 to about 20 and R is hydrogen or C₁-C₆ alkyl;
   (ii) about 0.1 to 15 mole percent, based on the total mole percent of diol moieties or diol and diamine moieties, of moieties of a poly(ethylene glycol) having the formula H(—OCH₂CH₂—)ₙOH wherein n is 2 to about 500, provided that the mole percent of such moieties is inversely proportional to the value of n; and
(4) 0 to about 40 mole percent moieties of a difunctional monomer reactant selected from hydroxycarboxylic acids, aminocarboxylic acids and aminoalkanols, wherein component (I) contains substantially equal mole proportions of acid equivalents (100 mole %) and diol or diol and diamine equivalents (100 mole %), wherein at least 20 weight percent of the groups linking the moieties of the monomeric units are ester linkages and wherein the inherent viscosity is at least 0.1 dL/g measured in a 60/40 parts by weight solution of phenol/tetrachloroethane at 25° C. and at a concentration of about 0.25 g of polymer in 100 ml of the solvent, and

(B) about 20 to 80 weight percent of the branched water-dispersible polyester made of the moieties of reaction products;
(1) at least one difunctional dicarboxylic acid which is not a sulfomonomer;
(2) about 1 to 20 mole percent, based on the total of acid, hydroxyl and amino equivalents, of residues of at least one difunctional sulfomonomer containing at least one sulfonate group bonded to an aromatic ring wherein the functional groups are hydroxyl, carboxyl, or amino;
(3) at least one difunctional reactant selected from a glycol or a mixture of glycol and diamine having two —NRH groups, the glycol containing two —C(R¹)₂ OH groups wherein R in the reactant is hydrogen or an alkyl group of 1 to 6 carbon atoms, and R¹ in the reactant is a hydrogen atom, an alkyl of 1 to 5 carbon atoms, or an aryl group of 6 to 10 carbon atoms;
(4) 0 to about 40 mole % of a difunctional reactant selected from hydroxycarboxylic acids having one —C(R—)₂—OH group, aminocarboxylic acids having one —NRH group, amino-alcohols having one —C(R—)₂—OH group and one —NRH group, or mixtures of said difunctional reactants wherein R in the reactant is hydrogen or an alkyl group of 1 to 6 carbon atoms; and
(5) 0.1 to 40 mole % of a “multifunctional” or “branch-inducing” reactant containing at least three functional groups selected from hydroxyl, carboxyl, amino, and mixtures thereof, wherein all stated mole percents are based on the total of all acid, hydroxyl, and amino group containing reactants being equal to 200 mole percent, and wherein the polymer containing a portion of the acid-group containing reactants (100 mole percent acid) to hydroxyl and amino-group containing reactants (100 mole %).

The branched, sulfonate-containing, water-dispersible polyesters, component (I) of the present invention comprise polyesters, including polyesteramides, having repeating, alternating residues or moieties of one or more dicarboxylic acid which is not a sulfomonomer and one or more diols or a combination of one or more diols and one or more diamines wherein the mole percentages are based on 100 mole percent dicarboxylic acid residues and 100 mole percent diol or diol and diamine residues, for a total of 200 mole percent. Alternatively, the polyesters can include residues of monomers having mixed functionality such as hydroxycarboxylic acids, aminocarboxylic acids and/or aminoalkanols.

Examples of suitable difunctional dicarboxylic acid monomers used include aliphatic dicarboxylic acids, alicyclic dicarboxylic acids, aromatic dicarboxylic acids, or mixtures of two or more of these acids. Examples of preferred suitable dicarboxylic acids include succinic; glutaric; adipic; azelaic; sebacic; fumaric; maleic; itaconic; 1,4-cyclohexanedicarboxylic; 1,3-cyclohexanedicarboxylic; phthalic; terephthalic; and isophthalic. If terephthalic acid is used as the dicarboxylic acid component of the polyester, superior results are achieved when at least 5 mole percent of one of the other acids is also used. It should be understood that the use of the corresponding acid anhydrides, esters, and acid chlorides of these acids is included in the term “dicarboxylic acid”.

The difunctional sulfomonomer residue or reactant is preferably a dicarboxylic acid or ester thereof containing a metal sulfonate group or a glycol containing a metal sulfonate group or a hydroxy acid containing metal sulfonate group —SO₃M attached to an aromatic nucleus, wherein M is hydrogen, NH₄⁺, or a metal ion selected from the group ions Li⁺, Na⁺, K⁺, Mg⁺⁺, Ca⁺⁺, Cu⁺⁺, Ni⁺⁺, Fe⁺⁺, and Fe⁺⁺⁺.

The aromatic nucleus to which the metal sulfonate group —SO₃M can be attached include benzene, naphthalene, anthracene, diphenyl, oxydiphenyl, sulfonyldiphenyl, and methylenediphenyl.

The cationic portion of a nonmetallic sulfonate group optionally present in the reactant can be a nitrogen-based cation derived from nitrogen-containing bases which may be aliphatic, cycloaliphatic or aromatic basic compounds that have ionization constants in water at 25° C. of 10⁻³ to 10⁻¹⁰, and preferably from 10⁻⁵ to 10⁻⁸. Especially preferred nitrogen-containing bases are ammonia, dimethylethanolamine, diethanolamine, triethanolamine, pyridine, morpholine, and piperidine, due to availability, cost, and usefulness. Such nitrogen-containing bases and cations derived therefrom are described in U.S. Pat. No. 4,304,901, the disclosure of which is incorporated herein by reference in its entirety.

It is preferred that difunctional sulfomonomer residue or reactant be present in a concentration of about 4 to 12 mole percent, more preferably about 6 to 10 mole percent, with a mole percent of about 8 being most preferred based on total acid equivalents.

Examples of preferred diols include diethylene glycol, triethylene glycol, and mixtures thereof. The preferred diol concentration is about 10 to 80 mole percent, however, and more preferably about 20 to 80 mole percent.

The moieties of (C)(ii) and (3)(i)are preferably at a concentration of about 1 to 5 mole percent, particularly when n is 10 to 30, due to the preferably higher softening points. The remaining portion of the glycol component of (C), and (B)(3) can consist of aliphatic, alicyclic, and aralkyl glycols. Examples of these glycols include neopentyl glycol; ethylene glycol; propylene glycol; 1,3-propanediol; 2,4-dimethyl-2-ethylhexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-trimethyl-1,6-hexanediol; thiodiethanol; 1,2-cyclohexanedimethanol; 1,3-cyclohexanedimethanol; 1,4-cyclohexanedimethanol; 2,2,4,4-tetramethyl-1,3-cyclobutanediol; p-xylylenediol and neopentyl glycol. Copolymers may be prepared from two or more of the above glycols. Preferred glycols, due to availability, cost, and usefulness, include neopentyl glycol, ethylene glycol, 1,3-propane diol, 1,4-butane diol, 1,6-hexane diol and cyclohexane dimethanols.

The amount of the moieties (C)(iii) present in the polyester is preferably a minor amount up to about 99 mole percent, more preferably 20 to 80 mole percent with a mole percent of about 30 to 70 being more preferred due to the preferred balance between the desired low Tg and the desired high softening point.

In regard to component D, (A)(4), and (B)(4), advantageous difunctional components include 5-aminopentanol-1,4-aminomethylcyclohexanemethanol, 5-amino-2-ethyl-pentanol-1,2-(4-β-hydroxyethoxyphenyl)-1-aminoethane, 3-amino-2,2-dimethylpropanol, and hydroxyethylamine. Generally these aminoalcohols contain from 2 to 20 carbon atoms, one —NRH group and one —CR₂—OH group.

Advantageous difunctional monomer components which are aminocarboxylic acids include aromatic, aliphatic, heterocyclic, and other types in regard to component (D), (A)(4), and (B)(4) and include lactams. Specific examples include 6-aminocaproic acid, its lactam known as caprolactam, omega aminoundecanoic acid, 3-amino-2-dimethylpropionic acid, 4-(β-aminoethyl)benzoic acid, 2-(β-aminopropoxy)benzoic acid, 4-aminomethylcyclohexanecarboxylic acid, and 2-(β-aminopropoxy) cyclohexanecarboxylic acid. Generally, these compounds contain from 2 to 20 carbon atoms. However, these moieties, component (D), (A)(4), and (B)(4) are less preferred, but they can be present. The concentration of these moieties is preferably from 0 to about 20 mole percent and more preferably less than 10 mole percent.

Preferred water dispersible linear polyesters of component (A) in the polyester blend contain diacid monomer residues that are about 75 to 90 mole percent isophthalic acid residues, and about 10 to 25 mole percent 5-sodiosulfoisophthalic acid monomer residues; and diol monomer residues of about 45 to 100 mole percent diethylene glycol monomer residues and 0 up to 55 mole percent 1,4-cyclohexanedimethanol.

The more preferred water dispersible linear polyesters of component (A) in the polyester blend have an inherent viscosity of 0.1 to 0.6, preferably 0.2 to 0.5, and a Tg range of about 25° to 88° C., preferably about 29° to 55° C. Related branched water-dispersible polyesters of component (B) of the polyester blend are disclosed in U.S. Pat. No. 5,218,042, the disclosure of which is incorporated herein by reference in its entirety.

The dispersible linear polyester composition of component (A) is blended with the branched water-dispersible polyester composition of component (B) at temperatures greater than 200° C., preferably about 225° C., for at least one hour. In the polyester blend composition the relative amounts of the two polyesters vary from about 20 to 80 weight percent of the polyester of (A) and about 20 to 80 weight percent of the polyester of (B).

The water-dispersible polyesters described herein have an inherent viscosity of at least 0.1 dL/g, preferably about 0.2 to 0.5 dL/g, measured in a 60/40 parts by weight solution of phenol/tetrachloroethane at 25° C. and at a concentration of about 0.25 g of polymer in 100 ml of solvent.

The preferred Tg of component I of the present polyester mixture according to the present invention is less than about 10° C., and more preferably may vary from about 4° to about −20° C., with a Tg of about 4° to −13° C. being most preferred.

Such branched sulfopoyesters are described in greater detail in U.S. Pat. No. 5,543,488, the entire disclosure of which is incorporated herein by reference.

The second component (II) of the sulfopolyester mixture is an alcohol. The alcohol can have from 1 to 9 carbon atoms and can include linear, branched, cyclic, and aromatic alcohols which may be substituted with one or more moieties having from 2 to 6 carbon atoms. Desirably, the alcohol has a boiling point of less than about 200° C. Preferably, the alcohol is a linear or branched alcohol having from 1 to 4 carbon atom, and most preferably the alcohol is selected from methanol, ethanol, isopropanol and mixtures thereof.

The amount of alcohol present in the pourable mixture is from about 5 to about 35 weight %, preferably from about 5 to about 30 weight %. One skilled in the art will understand that the ranges of such components, moieties or compounds expressed herein further includes all ranges therebetween and that the ranges expressed are for the sake of brevity of description.

The pourable, water-dispersible, branched sulfopolyester composition of the present invention can be prepared by stirring or otherwise agitating the mixture of alcohol and sulfopolyester as it is heated. The mixture is heated to at least about 60° C. with stirring until it becomes very liquid or homogeneous. The maximum temperature at which the pourable polyester can be prepared is the boiling point of the alcohol.

Advantageously, the pourable branched sulfopolyester mixture can be incorporated into liquid formulations at room temperature, i.e., at temperatures of from about 20° to about 50° C. and more preferably from about 25° to about 45° C. This includes adhesive formulations that are liquids at room temperature or any type of coating that is applied as a liquid to a substrate at room temperature where adhesion to the substrate is desirable. Such coatings include personal care products and cosmetics where adhesion to the hair, skin, or nails is desirable.

An advantage of the present invention is that a pourable, branched sulfopolyester can be prepared substantially without the presence of water. As used herein, “substantially without the presence of water” means that less than 30 weight % water can be added to mixture to make it pourable at room temperature. Preferably, less than 20 weight % water can be added to mixture to make it pourable at room temperature, more preferably, less than 10 weight % water can be added to the mixture and most preferably, less than 0.5 weight % water can be added to mixture to make it pourable at room temperature.

Advantageously, the pourable form of branched sulfopolyester of the present invention are suitable for use as adhesives for many substrates including non woven assemblies (such as non woven polypropylene), paper products (such as paper and paperboard), and wood pulp. An adhesive composition according to the present invention can be applied as a liquid in a solvent or in an aqueous solution at a concentration of about 0.5 to 80 weight percent with the remainder being solvent or water or mixtures thereof. Desirably, the pourable, branched sulfopolyester of the present invention comprises from about 0.5 to 35 weight % of an adhesive composition.

Surfactants and other additives can also be present to aid in the dispersibility of the adhesive composition. When applied as a solution, the adhesive compositions are generally applied by conventional processes, such as extrusion coating, spray coating, roll coating, brush coating, dip coating, etc.

The adhesive composition according to the present invention may be used as a hot melt adhesive or a pressure sensitive adhesive as described in U.S. Pat. No. 6,642,304 issued to Hansen et al. on Nov. 4, 2003; U.S. Pat. No. 6,162,890 issued to George et al., and U.S. Pat. No. 6,293,037 issued to Spada et al. on Sep. 25, 2001, the entire disclosures of which are incorporated herein by reference. In the case where the pourable sulfopolyester of the present invention is used in a pressure sensitive adhesive, the pourable sulfopolyester may be used as an emulsifier as is known to those skilled in the art and be present in an amount of from about 0.5 to about 15 weight %.

The adhesive compositions of the present invention are preferably not cross-linked since that would impair the water-dispersibility of the sulfopolyester. However, they may be cross-linked, to a certain extent with diisocyanates to improve strength and heat resistance although this is less preferred.

An adhesive composition according to the present invention may further contain from about 0.1 to about 0.5 weight % stabilizers. Suitable stabilizers include the antioxidant type and generally consist of sterically hindered phenols, or sulfur or phosphorous substituted phenols. An especially useful antioxidant is Irganox 1010 (from Ciba-Geigy, Hawthorne, N.Y.) which is a pentaerythritol tetrakis-3(3,5-di-tertiarybutyl-4-hydroxyphenyl)propionate.

Additional additives such as UV light absorbers, nucleating agents, colorants, pigments, solvents, and fillers can be present in small amounts as needed as is known to those skilled in the adhesive art.

Tackifiers may also be added to the polyester composition. Tackifiers are typically selected from at least one of the groups consisting of hydrocarbon resins, synthetic polyterpenes, functional copolymers, and rosin esters. Hydrocarbon resins are disclosed in U.S. Pat. No. 3,850,858 and functional copolymers, such as styrene-co-maleic anhydride, are well known in the art. Hydrocarbon resins, prepared according to U.S. Pat. No. 3,701,760, polyterpenes, and rosin esters can be used alone or in combinations. These tackifying resins, which preferably have softening points of at least 100° C. and most preferably 120° C., can be used in amounts of about 10% to 50% by weight of the adhesive composition, and preferably is about 25% to about 40% by weight. Suitable resins and rosin esters are the terpene polymers such as the polymeric, resinous materials including the dimers as well as higher polymers obtained by polymerization and/or copolymerization of terpene hydrocarbons such as the alicyclic, monocyclic, and bicyclic monoterpenes and their mixtures, including allo-ocimene, carene, isomerized pinene, pinene, dipentene, terpinene, terpinolene, limonene, turpentine, a terpene cut of fraction, and various other terpenes. Commercially available resins of the terpene type include the Zonarez terpene B-series and 7000 series from Arizona Chemical. Also included are the rosin esters with acid numbers above 5 such as the Zonatac resins from Arizona Chemical. Particularly useful materials are terpene mixtures containing a mixture of sulphate terpene, and at least 20% of at least one other terpene selected from the group consisting of pinene, limonene, or dipentene.

The pourable sulfopolyester of the present invention may also be used in a hair styling composition that includes from about 0.5 to about 50 weight %, preferably from about 0.5 to about 15 weight % of the pourable branched sulfopolyester mixture described above wherein the polymer after being applied to keratinous fibers and dried, provides a styling material having a glass transition temperature (Tg) of less than +10° C. and a detachment profile defined by: a) a maximum detachment force Fₘₐₓ of greater than 1 newton and b) a separation energy E_{s(m/g)} of the styling material placed in contact with a glass surface of less than 300 μJ when the glass temperature Tg is less than −15° C.

As used herein, Fₘₐₓ denotes the maximum tensile force, measured using an extensometer, required to detach the respective 38 millimeter square surfaces of two rigid, inert and non-absorbent substrates (A) and (B) placed opposite one another. The surfaces are coated beforehand with the composition at a rate of 53 /c μg/mm² where “c” is the dry matter concentration in the composition (in grams per gram of composition), i.e. the ratio of the mass of dry matter in the composition to the total mass of the composition. The surfaces are dried for 24 hours at 22° C. at a relative humidity of 50%. The surfaces are then subjected for 20 seconds to a compressive force of 3 newtons and finally subjected for 30 seconds to tension at a rate of 20 mm/minute.

As used herein, E_{s(m/g)} denotes the energy supplied by the extensometer in order to bring about the “separation” of the respective 38 mm² surfaces of two rigid, inert and non-absorbent substrates (C) and (D) placed opposite one another; one of the substrates consisting of polished glass and the other substrates being identical in nature to the above-defined substrates (A) and (B). The substrates have a surface which is coated with the composition at a rate of 53 /c μg/mm², where “c” is as defined above. The two surfaces of the substrates (C) and (D) are subjected subsequently for 20 seconds to a compressive force of 3 newtons and finally subjected for 30 seconds to tension at a rate of 20 mm/minute.

The solid, rigid, inert and non-absorbent substrates can be selected from those consisting of polyethylene, polypropylene, metal alloy and, more preferably, glass.

The composition according to the invention can comprise other constituents which are conventional in cosmetics, especially preservatives, perfumes, UV filters, and active hair care agents. It is understood that the person skilled in the art will know how to select these constituents and their amount in the composition according to the invention so as not adversely to affect its styling properties.

The compositions according to the invention can be provided in any form known from the prior art which is appropriate for their application to the hair, in particular in the form of a vaporizable composition, mousse, gel, or lotion.

The appropriate cosmetically acceptable vehicle is adapted to the method of application selected. The vehicle consists preferably of an appropriate solvent to which may be added additives such as gelling agents, foaming agents, and silicones.

It is understood that the person skilled in the art will know how to choose the additional constituents and their amount in the composition according to the invention, such as the constituents of the vehicle, so as not adversely to affect its styling properties. In particular, he or she will ensure that the Tg of the styling material is less than +10° C. and that the detachment profiles as indicated above are respected.

According to one embodiment, the composition is vaporizable either by means of a pump or is a pressurized aerosol composition which are well known in the art. Desirably, the vaporizable composition according to the invention is a solution or dispersion comprising at least one fixative polymer according to the invention and an appropriate solvent selected from water, an alcohol having from 1 to 4 carbon atoms or an aqueous-alcoholic mixture.

The present invention is illustrated in greater detail by the specific examples presented below. It is to be understood that these examples are illustrative embodiments and are not intended to be limiting of the invention, but rather are to be construed broadly within the scope and content of the appended claims. All parts and percentages in the examples are on a weight basis unless otherwise stated.

### EXAMPLES 1-3

Branched sulfopolyesters, (as taught in U.S. Pat. No. 5,543,488, are available from Eastman Chemical Company under the trade names AQ 1045, AQ 1350, and AQ 1950) were frozen, and broken into pieces having an average diameter of less than about 1 inch (2.54 cm) and were kept cold on dry ice until use. Pourable branched sulfopoyesters in accordance with the present invention were prepared by adding 200.0 grams of the specified branched sulfopolyester and 56.4 grams of anhydrous ethanol to a 500-ml mixing vessel equipped with a paddle stirrer and condenser.

The ingredients were heated, with stirring, to the temperature specified in Table 1 below. After the specified total time, each of the sulfopolyesters had dispersed in the ethanol to form a homogeneous liquid. The mixtures were translucent and remained homogenous after 2 weeks at room temperature. Based on the weight of ingredients added to the mixtures, these mixtures contain 78 wt % sulfopolyester solids.

The viscosity of the pourable sulfopolyester mixtures was measured at 25°, 45°, and 60° C. and at shear rates ranging from 1.0 to 400 radian/second. The viscosity ranges are given in Table 1 for the range of shear rates. The mixtures are slightly shear-thinning. The lower viscosity shown for each viscosity range was obtained at the highest shear rate tested. Samples having viscosities <1000 P are readily pourable, whereas samples having viscosities >2000 P were pourable but were slow flowing.

TABLE 1

| | | Dispersion | Viscosity | Viscosity | Viscosity |
|---|---|---|---|---|---|
| Ex. | Sulfopolyester | Temp., ° C. | at 25° C., P | at 45° C., P | at 60° C., P |
| 1 | AQ 1045 | 65 | 71.3-67.4 | 18.5-17.6 | 9.4-8.5 |
| 2 | AQ 1350 | 60 | 333-259 | 74.1-68.6 | 35.1-29.2 |
| 3 | AQ 1950 | 78 | 3276-1738 | 522-348 | 209-162 |

### EXAMPLES 4 & 5

Branched sulfopolyester AQ 1350 was frozen, and then broken up into small pieces having an average diameter of less than about 1 inch and were kept cold on dry ice until use. Pourable branched sulfopoyesters in accordance with the present invention were prepared by adding 200.0 g AQ 1350 and 80.0 g ethanol (Example 4) and 133.3 g ethanol (Example 5) to a 500-ml mixing vessel equipped with a paddle stirrer and condenser.

The ingredients of each were heated with stirring to 75° C. After 30 minutes total mixing time, the AQ 1350 of both Example 4 and Example 5 had dispersed in the ethanol to form a homogeneous, translucent mixture. Based on the weight of ingredients added to the mixtures, these mixtures contain 71 weight % solids (Example 4) and 60 weight % solids (Example 5).

The samples were allowed to sit overnight. A layer of ethanol was observed floating on top of the homogeneous mixtures. The ethanol top layer of Example 4 was less than that of Example 5. The sample of Example 4 was immediately stirred before measuring the viscosity. The results are shown in Table 2 below. The ethanol top layer of Example 5 was decanted. The percent solids of Example 5, with the top layer removed, was determined to be 78.5 weight %. This was determined gravimetrically by weighing the sample before and thereafter removing the volatile components by heating the sample overnight using a vacuum oven at a temperature of 100° C.

### EXAMPLE 6

Following the procedure of Example 4 above, 200.0 grams of branched sulfopolyester AQ 1350 and 56.4 grams methanol were charged to a 500-ml vessel equipped with a paddle stirrer and condenser.

The ingredients were heated with stirring to 66° C. After one hour total mixing time, the AQ 1350 had dispersed in the methanol to form a homogeneous, translucent mixture. The pourable mixture remained homogenous after 1 week. The mixture contained 78 weight % sulfopolyester solids, based on the weight of ingredients added to the mixture. The viscosity of this mixture over the shear rate range of 1.0 to 400 rad/s is shown in Table 2, and is compared to AQ 1350 in 56.4 g ethanol (Example 2). The viscosity of Example 6 was not determined at 60° C. because volatilization of the methanol at this temperature could cause the results to be inaccurate.

### EXAMPLE 7

Following the procedure of Example 4 above, 200.0 grams of branched sulfopolyester AQ 1350 and 80.0 g isopropanol were charged to a 500-ml vessel equipped with a paddle stirrer and condenser.

The ingredients were heated with stirring to 76° C. After 30 minutes total mixing time, the AQ 1350 had dispersed in the isopropanol to form a homogeneous opaque mixture. The pourable mixture contained 71 weight % sulfopolyester solids, based on the weight of ingredients added to the mixture. After sitting several days, a small amount of liquid was floating on top of the isopropanol-sulfopolyester mixture. This liquid was determined to be about 3 grams. Immediately after mixing, the viscosity of the mixture was determined over the shear rate range of 1.0 to 400 rad/s. The viscosity ranges are given in Table 2 for the range of shear rates. The mixtures are slightly shear-thinning, so the lower viscosity for each range was obtained at the highest shear rate tested. Results are compared to Example 4.

TABLE 2

| | | Viscosity | Viscosity | Viscostiy |
|---|---|---|---|---|
| Ex. | Alcohol | at 25° C., P | at 45° C., P | at 60° C., P |
| 6 | 22 wt % methanol | 179-194 | 55.0-59.8 | NA |
| 2 | 22 wt % ethanol | 333-259 | 74.1-68.6 | 35.1-29.2 |
| 4 | 29 wt % ethanol | 241-158 | 31.0-27.3 | 15.2-12.8 |
| 7 | 29 wt % isopropanol | 2970-1402 | 136-118 | 42.2-36.9 |

Based on the viscosity results shown in the Table 2, methanol and ethanol are the preferred alcohols for producing the pourable form of a branched sulfopolyester.

### COMPARATIVE EXAMPLE 8

A linear sulfopolyester, as taught in U.S. Pat. Nos. 6,162,890 and 5,709,940 (available from Eastman Chemical Company under the trade name AQ 2350) was frozen, and then broken up into small pieces having an average diameter of less than about 1 inch and were kept cold on dry ice until use. Two hundred grams of the linear sulfopolyester and 80.0 grams of anhydrous ethanol were charged to a 500-ml vessel equipped with a paddle stirrer and condenser.

The ingredients were heated with stirring to 68° C. After 1 hour the temperature was raised to 78° C. since it was apparent that the AQ 2350 was not dispersing in the ethanol. After 3 hours total mixing time a liquid phase and separate solid phase were still present in the vessel, although the solid phase had softened to some degree. After cooling to room temperature, the mixture had two layers, a liquid layer and solid opaque layer. The solid layer was not pourable at room temperature.

### COMPARATIVE EXAMPLE 9

Two hundred grams of the linear sulfopolyester of Comparative Example 8 was charged to a 500-ml vessel equipped with a paddle stirrer and condenser. Added to the vessel were 10.0 g water and 90.0 g ethanol.

The ingredients were heated with stirring to 78° C. After 30 minutes of mixing time it became apparent that the AQ 2350 was not dispersing in the liquid. An additional 130.0 grams of water and 50.0 grams of ethanol were added gradually over time until the AQ 2350 had dispersed. The total mixing time was 2 hours. Based on the weight of ingredients added to the mixture, the final mixture contains 42 weight % solids. After cooling to room temperature the viscous mixture was hazy. After sitting 4 weeks, the mixture showed slight separation of solids from the liquid.

### COMPARATIVE EXAMPLE 10

Two hundred grams of a pelletized linear sulfopolyester, (as taught in U.S. Pat. No. 6,007,794 and available from Eastman Chemical Company under the trade name AQ 48) and 133.3 g anhydrous ethanol were charged to a 500-ml vessel equipped with a paddle stirrer and condenser.

The ingredients were heated with stirring to 75° C. After 45 minutes of mixing time the AQ 48 pellets had clumped around the sides of the vessel and it became apparent that the AQ 48 was not dispersing in the liquid. Additional ethanol was added, and then water was added gradually until the AQ 48 had dispersed. The total mixing time was 2.9 hours. The amount of water in the final mixture was 250 g. The amount of ethanol in the final mixture was 200 g. Based on the weight of ingredients added to the mixture, the final mixture contains 31 weight % solids. After cooling to room temperature, the mixture was hazy. After sitting 5 weeks, there was evidence of slight settling of solids from the dispersion.

### COMPARATIVE EXAMPLE 11

Following the procedure of Example 4 above, 200.0 g of the branched sulfopolyester AQ 1350, 80.0 g anhydrous ethanol and 120.0 g water were charged to a 500-ml vessel equipped with a paddle stirrer and condenser.

The ingredients were heated with stirring to 60° C. After one hour total mixing time, the AQ 1350 had solubilized in the ethanol-water blend to form a clear homogeneous mixture. After sitting 7 weeks, the mixture remained clear. Based on the weight of ingredients added to the mixture, the final mixture contains 50 weight % solids, 20 weight % ethanol, and 30 weight % water.

The viscosity of the sulfopolyester solution was measured at 25, 45, and 60° C. and at shear rates ranging from 1.0 to 400 rad/s. Viscosities at 1.0 rad/s are given in Table 3 below. The viscosities for Example 2 are given for comparison.

TABLE 3

| | Concentration | | Viscosity At | Viscosity At | Viscosity At |
|---|---|---|---|---|---|
| Ex | of AQ 1350 | Solvent | 25° C., P | 45° C., P | 60° C., P |
| 11 | 50.0 wt % | Ethananol-Water | 414 | 52.1 | 14.8 |
| 2 | 78.0 wt % | Ethanol only | 333 | 74.1 | 35.1 |

The data in Table 3 show that the sample of Comparative Example 11 has a higher viscosity at room temperature at 1.0 rad/s than the sample of Example 2. A lower viscosity is desirable to improve pourability. Although the viscosities of Comparative Example 11 are lower at the higher temperatures of 45° and 60° C., the composition of Example 2 is preferred because it has higher solids and hydrolysis of the sulfopolyester is not a concern since there is very little or no water in the pourable mixture of the present invention.

### EXAMPLE 12

The purpose of this example is to show that the sulfopolyester-ethanol mixture of Example 4 can be diluted with water to achieve a homogeneous clear mixture, similar in appearance to the sample of Comparative Example 11.

At room temperature, 13.44g of the sample of Example 4 was weighed into a vial. Water was added, 6.04 g, to achieve a final concentration of 50 weight % AQ 1350 sulfopolyester, 20 weight % ethanol, and 30 weight % water. The sample was mixed with a spatula. After sitting overnight to allow air bubbles to dissipate, the sample has the same appearance and viscosity as the sample of Comparative Example 11. There was no separation and no sedimentation after 4 weeks.

### COMPARATIVE EXAMPLE 13

The branched sulfopolyester AQ 1350 was frozen and then broken up into small pieces having an average diameter of less than about 1 inch (2.54 cm) and were kept cold on dry ice until use. Two hundred grams of the AQ 1350 and 100.0 g of water were charged to a 500-ml mixing vessel equipped with a paddle stirrer and condenser.

The ingredients were heated with stirring to 75° C. After 45 minutes the AQ 1350 appeared to be completely dispersed, however the mixture was extremely viscous. Additional water was added gradually, and the temperature was raised to 85° C. After 3 hours total mixing time, the mixture was poured from the mixing vessel while still hot, i.e. temperature close to 85° C. While being removed from the vessel, the mixture cooled somewhat and became extremely viscous making it difficult to remove from the vessel. The total amount of water in the final mixture was 156.9 g. The sample appeared homogeneous and translucent. Viscosity was measured at 25, 45, 60, and 85° C. and at shear rates ranging from 1.0 to 400 rad/s. The viscosity ranges are given in Table 4 for the range of shear rates. The mixture is very shear-thinning; i.e., the lower viscosity given for each temperature was obtained at the highest shear rate tested, 400 rad/s.

TABLE 4

| Temp. | Viscosity over shear rate range: |
|---|---|
| ° C. | 1.0 to 400 rad/s, P |
| 25 | 43,850-2277 |
| 45 | 6162-306 |
| 60 | 2234-135 |
| 85 | 1296-65.3 |

This example shows that the branched sulfopolyester dispersions in alcohol are truly unique compared to dispersions in water. A much higher solids content can be achieved in alcohol, providing a pourable product at or near room temperature.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

We claim:

1. A branched sulfopolyester mixture comprising:
I. from about 65 to about 95 weight % of a branched water-dispersible polyester; and
II. from about 5 to about 35 weight % of an alcohol,
wherein said sulfopolyester mixture is pourable at a temperature of from about 20° C. to about 50° C.

2. The pourable sulfopolyester mixture of claim 1 wherein said component I comprises residues or moieties of reaction products:
(A) at least one difunctional dicarboxylic acid which is not a sulfomonomer;
(B) about 2 to 30 mole percent, based on the total of all acid, hydroxyl and amino equivalence, of residues of at least one difunctional sulfomonomer containing at least one sulfonate group bonded to an aromatic ring wherein the functional groups are hydroxyl, carboxyl, or amino;
(C) at least one diol or a mixture of a diol and a diamine comprising:
(i) about 0.1 to 85 mole percent, based on the total mole percent of diol moieties or diol and diamine moieties, of a diol or diamine having the formula H(—OCH₂CH₂—)ₙOH and HRN(—(CH₂CH₂O—))ₙNHR wherein n is 2 to about 20 and R is hydrogen or C₁-C₆ alkyl provided that the mole percent of such moieties is inversely proportional to the value of n;
(ii) about 0.1 to 15 mole percent, based on the total mole percent of diol moieties or diol and diamine moieties, of moieties of a poly(ethylene glycol) having the formula H(—OCH₂CH₂—)ₙOH wherein n is 2 to about 500, provided that the mole percent of such moieties is inversely proportional to the value of n; and
(iii) 0 to greater than about 99 mole percent of the diol component or diol and diamine mixture being selected from the group consisting of a glycol and a mixture of glycol and diamine having two —NRH groups, the glycol containing two —C(R¹)² OH groups wherein R¹ in the reactant is a hydrogen atom, an alkyl of 1 to 5 carbon atoms, or an aryl group of 6 to 10 carbon atoms;
(D) 0 to about 40 mole % of a difunctional monomer reactant selected from the group consisting of hydroxycarboxylic acids having one —C(R—)₂—OH group, aminocarboxylic acids having one -NRH group, aminoalkanols having one —C(R—)₂—OH group and one —NRH group and mixtures of said difunctional reactants wherein R in the reactant is hydrogen or an alkyl group of 1 to 6 carbon atoms; and
(E) about 0.1 to 40 mole % of a “multifunctional” or “branch-inducing” reactant containing at least three functional groups selected from hydroxyl, carboxyl, amino, and mixtures thereof; and
wherein said component (I) of the present invention, contains 100 mole % of acid equivalents and 100 mole % of diol or diol and diamine equivalents, wherein at least 20 weight percent of the groups linking the moieties of the monomeric units are ester linkages, and wherein the inherent viscosity of the polyester is at least 0.1 dL/g measured in a 60/40 parts by weight solution of phenol/tetrachloroethane at 25° C. and at a concentration of about 0.5 g of polymer in 100 ml of the solvent and the glass transition temperature Tg is no greater than 20° C.

3. The pourable sulfopolyester mixture of claim 1 wherein said component II is an alcohol having from 1 to 9 carbon atoms.

4. The pourable sulfopolyester mixture of claim 3 wherein said alcohol is selected from the group consisting of linear, branched, cyclic, and aromatic alcohols.

5. The pourable sulfopolyester mixture of claim 4 wherein said alcohol is substituted with one or more moieties having from 2 to 6 carbon atoms.

6. The pourable sulfopolyester mixture of claim 1 wherein said component II is selected from the group consisting of methanol, ethanol and isopropanol.

7. The pourable sulfopolyester mixture of claim 1 wherein said component I(A) is dimethyl-1,4-cyclohexane dicarboxylate.

8. An adhesive composition comprising from about 0.5 to about 80 weight % of the pourable branched sulfopolyester of claim 1.

9. The adhesive composition of claim 8 wherein said pourable branched sulfopolyester is present in an amount of from about 0.5 to 35 weight %.

10. The adhesive composition of claim 8 wherein component II of said pourable branched sulfopolyester is an alcohol having from 1 to 9 carbon atoms.

11. The adhesive composition of claim 10 wherein said alcohol is selected from the group consisting of linear, branched, cyclic, and aromatic alcohols.

12. The adhesive composition of claim 10 wherein said alcohol is selected from the group consisting of methanol, ethanol and isopropanol.

13. The adhesive composition of claim 8 further comprising additional components selected from the group consisting of plasticizers, tackifiers, resins, elastomers, low molecular weight polyolefins and mixtures thereof.

14. A personal care product comprising from about 0.5 to about 50 weight % of the pourable, branched sulfopolyester of claim 1.

15. The personal care product of claim 14 wherein the amount of branched sulfopolyester is from about 0.5 to about 15 weight %.

16. The personal care product of claim 14 wherein component II of said pourable branched sulfopolyester is an alcohol having from 1 to 9 carbon atoms.

17. The personal care product of claim 14 wherein said alcohol is selected from the group consisting of linear, branched, cyclic, and aromatic alcohols.

18. The personal care product of claim 14 wherein said alcohol is selected from the group consisting of methanol, ethanol and isopropanol.

19. The personal care product of claim 14 further comprising preservatives, perfumes, UV filters, and active haircare agents.

20. The personal care product of claim 13 comprising a hair fixative.
